(19) United States
(12) Patent Application Publication
(10) Pub. No.: US 2026/0268157 A1
(43) Pub. Date: Sep. 10, 2026

(54) GUARD RAILING OF A LARGE LANGUAGE MODEL USING PRODUCTION DATA AUGMENTATION

(71) Applicant: International Business Machines Corporation, Armonk, NY (US)

(72) Inventors: Anna Lisa Gentile, San Jose, CA (US); Kellen Cheng, Princeton, NJ (US); Chad Eric DeLuca, Morgan HIll, CA (US)

(73) Assignee: International Business Machines Corporation, Armonk, NY (US)

(21) Appl. No.: 19/073,433

(22) Filed: Mar. 7, 2025

(51) Int. Cl. G06N 3/096; G06N 3/045

(52) U.S. Cl. CPC G06N 3/096; G06N 3/045

(57) ABSTRACT

An embodiment includes training a classification model by sending data from a seed dataset to a model training interface of the classification model where the seed dataset comprises a classification and determining a first benchmark metric. The embodiment includes iteratively executing the classification model on a production dataset to determine a set of samples predicted to comprise the classification. The embodiment includes generating an annotation of the set of samples based on clustering. The embodiment includes issuing an instruction via a fine-tuning interface of the classification model to modify a configuration parameter of the classification model based on the annotation to cause the classification model to determine a second benchmark metric and establishing a checkpoint wherein the checkpoint is incremented for each iteration of the production dataset. The embodiment also includes executing an instruction whether to distill an update of the classification model.

### BACKGROUND

The present invention relates generally to machine learning. More particularly, the present invention relates to a method, system, and computer program for Guard Railing of a Large Language Model Using Production Data Augmentation.

Large language models (LLMs) are advanced artificial intelligence systems designed to understand, interpret, and generate human-like text. They are a type of deep learning model that have been trained on a wide variety of texts to understand how characters, words, and sentences function together. Deep learning involves the probabilistic analysis of unstructured data, which eventually enables the deep learning model to recognize distinctions between pieces of content without human intervention.

LLMs may be trained via tuning: they are fine-tuned or prompt-tuned to the particular task, such as interpreting questions and generating responses, or translating text from one language to another. Large language models'ability to generate text in real-time has made them invaluable in enhancing search engines, powering virtual assistants, and improving language translation services. Beyond these examples, LLMs are also transforming more intelligent and adaptive applications.

### SUMMARY

The illustrative embodiments provide for Guard Railing of a Large Language Model Using Production Data Augmentation. An embodiment includes training a classification model by sending data from a seed dataset to a model training interface of the classification model wherein the seed dataset comprises a classification and determining a first benchmark metric. The embodiment includes iteratively executing the classification model on a production dataset wherein for each iteration of the production dataset, the classification model executes to determine a set of samples wherein each sample from the set of samples is predicted to comprise the classification. The embodiment includes generating an annotation of the set of samples based on clustering of the set of samples. The embodiment includes issuing an instruction via a fine-tuning interface of the classification model, the instruction executing to modify a configuration parameter of the classification model based on the annotation to cause the classification model to determine a second benchmark metric and establishing a checkpoint wherein the checkpoint is incremented for each iteration of the production dataset. The embodiment also includes executing a comparison instruction to output a result of a determination whether to distill an update of the classification model based on a comparison between the first benchmark metric and the second benchmark metric.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of generating an annotation of a production dataset in an environment in accordance with an illustrative embodiment;

FIG. 3 depicts a diagram of a health-advice benchmark dataset that has been curated and annotated to evaluate the classification model's capability in recognizing health advice in an environment in accordance with an illustrative embodiment;

FIG. 4 depicts a diagram of distilling an update of the classification model in an environment in accordance with an illustrative embodiment;

FIG. 5 depicts a flowchart of a process of guard railing of a large language model using production data augmentation in an environment in accordance with an illustrative embodiment; and

FIG. 6 depicts a system diagram that illustrates an example system for guard railing of a large language model using production data augmentation in an environment in accordance with an illustrative embodiment.

### DETAILED DESCRIPTION

Large language models (LLMs) have seen increasing popularity in daily use, with their widespread adoption by many corporations as virtual assistants, chatbots, predictors, and many more. The growing influence of these technologies raises the need for safeguards and guardrails to ensure that the outputs from LLMs do not mislead or harm users. This is especially true for highly regulated domains such as healthcare, where misleading advice may influence users to commit malpractice unknowingly. Moreover, these models are typically trained on massive large-scale datasets, and if developed without proper governance, they can readily generate outputs that are not only inaccurate but potentially harmful. Therefore, it is crucial to establish safeguards to ensure their responsible use especially in heavily regulated industries, such as healthcare, law, and finance, that deal with critical decision-making.

General solutions to safeguard LLMs fall into two categories: (i) external models or filters to prevent harmful outputs and/or (ii) specific safety training in the fine-tuning phase. Currently, there is no way for recognizing advice in the context of safeguarding LLMs. Guardrails technologies aim to mitigate this risk by filtering LLMs'input/output text through various detectors. However, developing and maintaining robust detectors has many challenges, one of which is the difficulty in acquiring production-quality labeled data on real LLM outputs before deployment.

The following description provides examples of embodiments of the present disclosure, and variations and substitutions may be made in other embodiments. Several examples will now be provided to further clarify various aspects of the present disclosure.

Example 1: A computer-implemented method that comprises training a classification model by sending data from a seed dataset to a model training interface of the classification model wherein the seed dataset comprises a classification and determining a first benchmark metric. The method further comprises iteratively executing the classification model on a production dataset wherein for each iteration of the production dataset, the classification model executes to determine a set of samples wherein each sample from the set of samples is predicted to comprise the classification. The method further comprises generating an annotation of the set of samples based on clustering of the set of samples. The method further issuing an instruction via a fine-tuning interface of the classification model, the instruction executing to modify a configuration parameter of the classification model based on the annotation to cause the classification model to determine a second benchmark metric and establishing a checkpoint wherein the checkpoint is incremented for each iteration of the production dataset. The method further comprises executing a comparison instruction to output a result of a determination whether to distill an update of the classification model based on a comparison between the first benchmark metric and the second benchmark metric.

The above limitations advantageously enable use of a classification model to gather an initial set of annotations of production data. The limitations enable the positive result of the classification model, cluster them according to their word embeddings, and verifies the correctness of a few data points for each cluster and propagates the annotation to the entire cluster. The limitations enable a distillation procedure upon encountering performance degradation. The above limitations advantageously enable improvements to the computer resources since latency of model operation is reduced, and due to distillation, there is an improvement in the efficient use of memory and a reduction in computer data storage usage.

The term “classification model” as used herein, and without implying any limitation thereto, may refer to a type of machine learning model that divides data points into predefined groups called classes based on classifications.

The term “seed dataset” as used herein, and without implying any limitation thereto, may refer to a set of initial data used to train a classification model. A seed dataset may be a dataset in a particular domain including but not limited to academic literature, conversations, and/or online data, in video, audio and/or text format.

The term “production dataset” as used herein, and without implying any limitation thereto, may refer to a dataset comprising academic papers and conversational data about a subject matter as well as general content such as general conversation.

The term “annotation” as used herein, and without implying any limitation thereto, may refer to a process of labeling data to show the outcome for which the machine learning model is trained to predict comprising labeling, tagging, transcribing, and/or processing data with the features a machine learning system is intended to learn to recognize.

The term “fine-tuning” as used herein, and without implying any limitation thereto, may refer to a machine learning process of adapting a pre-trained model for specific tasks or use cases. Fine-tuning may use the weights of a pre-trained model as a starting point for further training on a smaller dataset of examples that more directly reflect the specific tasks and use cases for which a model will be utilized.

The term “distill” as used herein, and without implying any limitation thereto, may refer to training a more compact model to mimic a another model for instance to train the student model to match the predictions made by the teacher model.

The term “benchmark” as used herein, and without implying any limitation thereto, may refer to a standardized dataset or set of tasks used to evaluate and compare the performance of different machine learning models, allowing objective assessment of how well the algorithms perform against a common standard, often by measuring metrics like accuracy, precision, or recall on that dataset; essentially acting as a reference point to gauge progress and identify the best performing models within a specific domain.

The term “checkpoint” as used herein, and without implying any limitation thereto, may refer to a snapshot of a model's state including weights, biases, and other parameters.

Example 2: The limitations of Example 1, where the update of the classification model comprises distilling a model based on randomly sampled first k data points from a current production dataset and randomly sampled second k data points from a production dataset associated with the classification model with a previous checkpoint.

The above limitations advantageously enable the classification model to be updated to improve its performance with a model distilled from randomly sampled first k data points from a current production dataset and randomly sampled second k data points from a production dataset. Additionally, the limitations realize the benefits described with respect to Example 1.

Example 3: The limitations of Example 2, further comprising generating a first soft label using the classification model with a current checkpoint on the first k data points and a second soft label using a classification model with a previous checkpoint on the second k data points.

The above limitations advantageously enable using soft labels to distill an updated classification model. Additionally, the limitations realize the benefits described with respect to Examples 1-2.

The term “soft label” as used herein, and without implying any limitation thereto, may refer to a label that expresses a probability distribution across different classes rather than a single definitive class, essentially indicating the degree of confidence or uncertainty about the true class of a data point.

Example 4: The limitations of Example 1, where generating the annotation comprises generating an annotation for a centroid of each cluster generated by the clustering and applying the annotation to all the points in the cluster.

The above limitations advantageously enable an annotation for the entire cluster based on the centroid of the cluster. Additionally, the limitations realize the benefits described with respect to Examples 1-3.

Example 5: The limitations of Example 1, where the clustering comprises generating an embedding for each sample of the set of samples and applying a clustering algorithm on the embedding.

The above limitations advantageously enable clustering to be performed using an embedding of each sample. Additionally, the limitations realize the benefits described with respect to Examples 1-4.

Example 6: The limitations of Example 1, where determining the first benchmark metric and the second benchmark metric uses a benchmark comprising of academic and conversational data.

The above limitations advantageously enable using a benchmark comprising of academic and conversational data to evaluate and compare the performance of the classification model. Additionally, the limitations realize the benefits described with respect to Examples 1-5.

Example 7: The limitations of Example 1, where the comparison is based on whether the second benchmark metric is below a threshold compared to the first benchmark metric.

The above limitations advantageously enable a decision whether to distill an update of the classification model to be based on a threshold. Additionally, the limitations realize the benefits described with respect to Examples 1-6.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 6 realizes the benefits described with respect to Examples 1-7. The computer program product of Example 6 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 9 realizes the benefits described with respect to Examples 1-7. The computer system of Example 9 can advantageously be implemented into a variety of computer devices.

Example 10: A computer-implemented method that comprises training a classification model by sending data from a seed dataset to a model training interface of the classification model wherein the seed dataset comprises a classification and determining a first benchmark metric. The method further comprises iteratively executing the classification model on a production dataset wherein for each iteration of the production dataset, the classification model executes to determine a set of samples wherein each sample from the set of samples is predicted to comprise the classification. The method further comprises outputting from the classification model via an output interface of the classification model, an annotation of the set of samples based on clustering of the set of samples. The method further issuing an instruction via a fine-tuning interface of the classification model, the instruction executing to modify a configuration parameter of the classification model based on the annotation to cause the classification model to determine a second benchmark metric and establishing a checkpoint wherein the checkpoint is incremented for each iteration of the production dataset. The method further comprises executing a comparison instruction to output a result of a determination whether to distill an update of the classification model based on a comparison between the first benchmark metric and the second benchmark metric. The method further comprises wherein the update of the classification model comprises distilling a model based on randomly sampled first k data points from a current production dataset and randomly sampled second k data points from a production dataset associated with the classification model with a previous checkpoint. The above limitations realize the technical benefits described with respect to Examples 1-7.

Aspects of the present disclosure can be implemented in a variety of technical use cases. The following use cases are merely exemplary and are not intended to limit the scope of the disclosure.

In a use case, a classification model is trained using a seed dataset of academic literature, and conversation dataset in the health advice domain where the classification is health advice. The classification model is benchmarked using a curated benchmark dataset. A set of samples where each sample from the set of samples is predicted to comprise the health advice classification is determined by the classification model on production dataset comprising data from online healthcare forums that includes health advice as well as general conversation content. A clustering algorithm is applied to the set of samples, and each set is annotated. The classification model is fine-tuned to modify a configuration parameter of the classification model based on the annotations, and then checkpointed and benchmarked. The benchmark metrics are compared to determine whether to distill an update of the classification model. The classification model executes on each iteration of a new production dataset. If the comparison is below a threshold to indicate that the model performance has declined, a model is distilled based on randomly sampled first k data points from a current production dataset and randomly sampled second k data points from a production dataset associated with the classification model with a previous checkpoint.

The present disclosure provides for a method, a machine-readable medium, and a system for Guard Railing of a Large Language Model Using Production Data Augmentation.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

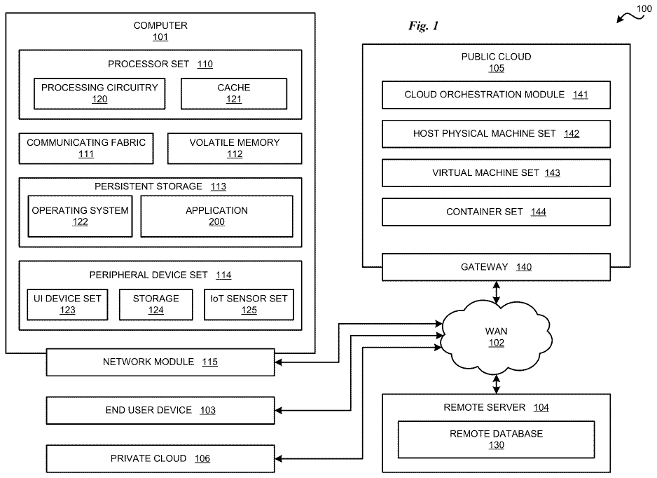

With reference to FIG. 1, this figure depicts a block diagram of a computing environment 100. Data center environment 100 contains an example of an environment for the execution of at least some of the computer code involved in performing the inventive methods, such as an Application 200 that provides Guard Railing of a Large Language Model Using Production Data Augmentation. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

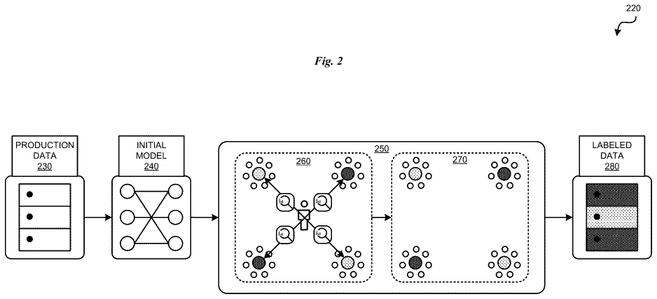

FIG. 2 depicts a diagram of generating an annotation of a production dataset in an environment in accordance with an illustrative embodiment. In a particular embodiment, the components of the diagram 220 show aspects of the Application 200 of FIG. 1.

In the illustrated embodiment, to annotate production data 230, a classification model 240 is used to generate annotated labels for samples of the production data 250 comprising generating a set of samples where each sample from the set of samples is predicted to comprise a classification 260. The samples are clustered using a clustering algorithm that cluster the samples by their embeddings. A cluster centroid may be annotated, before propagating this annotated label to all cluster members 270. The model is then fine-tuned using the annotated labels and the production data 280. For example, a production dataset may comprise academic papers and conversational data about a healthcare topic as well as general content such as general conversation. The classification model, which has been initialized and trained on a seed dataset of academic health advice, samples the production dataset to determine a set of samples where each sample from the set of samples is predicted to comprise the health advice classification, in contrast to general conversation topics. An embedding algorithm is used to produce the embeddings of all the collected samples, i.e. all samples the model determines are positive, and apply a clustering algorithm on the embedded data, with an arbitrary fixed number of clusters.

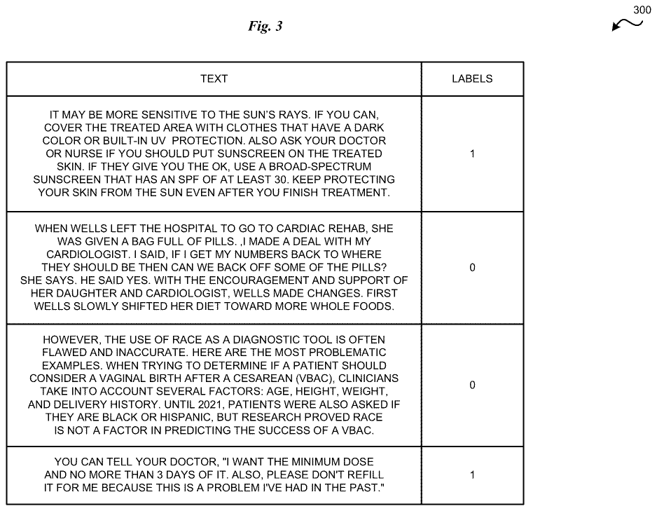

FIG. 3 depicts a diagram of a health-advice benchmark dataset that has been curated and annotated to evaluate the classification model's capability in recognizing health advice in an environment in accordance with an illustrative embodiment. In a particular embodiment, the components of the diagram 300 show aspects of the Application 200 of FIG. 1.

In the illustrated embodiment, a classification model is benchmarked using a benchmark dataset initially after the model has been trained with the seed dataset. The next time the model is benchmarked is after fine-tuning the model with the production data and the annotated samples. For example, in a healthcare domain, the classification model determines the samples of the production data that comprises health advice, as opposed to not health advice or just general content. Cluster all samples that are classified as positive i.e. expressing health-advice and generate an annotation for a centroid of each cluster generated by the clustering and applying the annotation to all the points in the cluster. Fine-tune the model on all the production data, with the annotated labels for the positively classified samples (to minimize false positives). The fine-tuned model is then benchmarked.

In embodiments, a “benchmark” refers to a standardized dataset or set of tasks used to evaluate and compare the performance of different machine learning models, allowing objective assessment of how well the algorithms perform against a common standard, often by measuring metrics like accuracy, precision, or recall on that dataset; essentially acting as a reference point to gauge progress and identify the best performing models within a specific domain. For example, a health advice benchmark dataset is a dataset that has been curated and annotated to evaluate the classification model's capability in recognizing classifications such as health advice. The diagram shows that samples with text, for instance rows 1 and 4 comprise health advice and should be annotated or labeled with a positive number by a classification model in the health advice domain. In another example, the benchmark dataset comprises a academic and conversational data in video, audio, and/or text or similar formats.

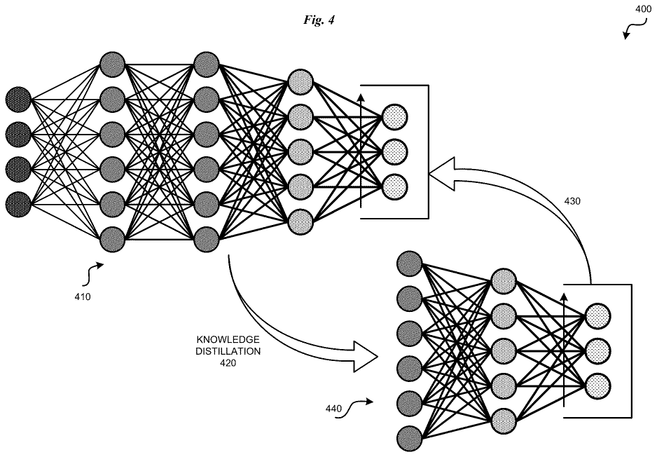

FIG. 4 depicts a diagram of distilling an update of the classification model in an environment in accordance with an illustrative embodiment. In a particular embodiment, the components of the diagram 400 show aspects of the Application 200 of FIG. 1.

In the illustrated embodiment, initially, a complex and accurate teacher model 410 (often a deep neural network) is trained on the target task using a large dataset. The teacher model's knowledge, which includes the probability distribution over classes for each input, is distilled 420 into a simpler student model 440. This transfer of knowledge is achieved by having the student model mimic the teacher model's behavior 430. The student model is trained on the same dataset as the teacher model but uses the teacher's soft labels (probability distributions) instead of the hard labels (class indices). This means that instead of predicting, for instance, “Class A” or “Class B,” the student aims to predict a distribution over all classes. A temperature parameter is often introduced during knowledge distillation. This parameter controls the “softness” of the teacher's output. A higher temperature makes the output distribution softer, while a lower temperature makes it sharper. Tuning this parameter can have a significant impact on the student's performance.

The goal of knowledge distillation is to train a more compact model to mimic a larger, more complex model. Whereas the objective in conventional deep learning is to train a neural network to bring its predictions closer to the output examples provided in a training data set, the primary objective in distilling knowledge is to train the student network to match the predictions made by the teacher network. Knowledge distillation (KD) may be applied to large deep neural networks with many layers and learnable parameters. This process makes it particularly relevant to the ongoing proliferation of massive generative AI models with billions of parameters.

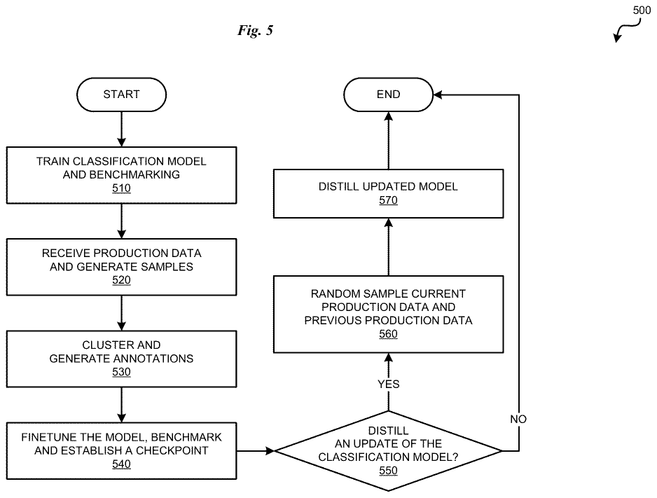

FIG. 5 depicts a flowchart of a process of guard railing of a large language model using production data augmentation in an environment in accordance with an illustrative embodiment. In a particular embodiment, the components of the diagram 500 show aspects of the Application 200 of FIG. 1.

In the illustrated embodiment, the process begins at step 510 by training a classification model and benchmarking. For example, the classification model is trained by sending data from a seed dataset to a model training interface of the classification model where the seed dataset comprises a classification. In embodiments, the seed dataset may be a dataset in a particular domain including but not limited to academic literature, online data, in video, audio and/or text format. For instance, in the health advice domain, a seed dataset may comprise academic papers, clinical notes, online health resources and/or social media, and the classification may comprise health advice classification.

In some embodiments, the trained classification model comprises a known Bidirectional and Auto-Regressive Transformer (BART) with about 400 million parameters. BART is a denoising autoencoder that is a pre-trained sequence-to-sequence method, that uses masked language modeling for Natural Language Generation and Translation. BART architecture is similar to an encoder-decoder network except that it uses a combination of Bidirectional Encoder Representations from Transformers (BERT) and Generative Pre-trained Transformer (GPT) models. The BART models can be fine-tuned over small supervised datasets to create domain-specific tasks.

BART's primary task is used to generate clean semantically coherent text from corrupted text data but it can also be used for a variety of different NLP sub-tasks like language translation, question-answering tasks, text summarization, paraphrasing, etc. As BART is an autoencoder model, it consists of an encoder model and a decoder model. For its encoder model, BART uses a bi-directional encoder that is used in BERT, and for its decoder mode, it uses an autoregressive decoder that forms the core aspect of a GPT-1 model.

An autoregressive decoder is a neural network architecture that takes the previous input tokens as well as the current token to predict the next token at every time step. It is important to remember that the input accepted by a decoder is an embedding created by its corresponding encoder network.

For a given input text sequence, the BERT (Bidirectional Representation for Transformers) encoder network generates an embedding for each token in the input text and an additional sentence-level embedding vector. The GPT decoder network learns this token-level and sentence-level embedded information and its existing pre-trained weights to generate clean semantically close text sequences.

In an embodiment, the trained classification model is benchmarked by determining a first benchmark metric. As described earlier, the first benchmark metric may be an objective assessment of how well the algorithms perform against a common standard benchmark dataset, such as a dataset that has been curated and annotated to evaluate the classification model's capability in recognizing classifications such as health advice, by measuring metrics like accuracy, precision, or recall on that dataset; essentially acting as a reference point to gauge progress and identify performance.

At step 520, the process performs receiving production data and generate samples. For example, production data may comprise data that has not been classified, annotated or processed by the classification model including but not limited to academic literature, online data, related and/or unrelated to a classification in a specific domain, in video, audio and/or text format. For each iteration of received production data, the classification model executes to determine a set of samples to determine a set of samples wherein each sample from the set of samples is predicted to comprise the classification. For instance, in a health advice domain, the classification model determines samples that are classified as positive, i.e. expressing health-advice.

At step 530, clustering and generating annotations is performed on the samples predicted to comprise the classification. For example, using an embedding algorithm (for instance using the previously checkpointed model) to produce the embeddings of all the collected samples. Embedding is a means of representing objects like text, images and audio as points in a continuous vector space where the locations of those points in space are semantically meaningful to machine learning (ML) algorithms. Apply a known clustering algorithm on the embedded data. Some common classification machine learning algorithms include Logistic Regression, Decision Tree, Naive Bayes, Support Vector Machine (SVM), K-Nearest Neighbors (KNN), Random Forest, and Gradient Boosting, all of which are used to categorize data into predefined classes based on given features and/or embeddings.

In an embodiment, an annotation of the set of samples is generated based on clustering of the set of samples. For example, the centroid of each cluster is annotated. In another example, one randomly selected data point from each cluster is annotated. That label is then given to all the points in that cluster. In some embodiments, the classification model outputs the annotation via an output interface of the classification model.

At step 540, the process performs fine-tuning of the classification model, benchmark and establishing a checkpoint. In an embodiment, an instruction is issued via a fine-tuning interface of the classification model to modify a configuration parameter of the classification model based on the annotation the classification model. The classification model fine-tunes the production data using the annotated labels for the positively classified samples. Fine-tuning in machine learning is the process of adapting a pre-trained model for specific tasks or use cases. It has become a fundamental deep learning technique, particularly in the training process of foundation models used for generative AI. Fine-tuning could be considered a subset of the broader technique of transfer learning: the practice of leveraging knowledge an existing model has already learned as the starting point for learning new tasks.

Fine-tuning may hone easier and cheaper capabilities of a pre-trained base model that has already acquired broad learnings relevant to the task at hand than it is to train a new model from scratch for that specific purpose. This is especially true for deep learning models with millions or even billions of parameters, like the large language models (LLMs) for tasks such as classification as described herein. Fine-tuning uses the weights of a pre-trained model as a starting point for further training on a smaller dataset of examples that more directly reflect the specific tasks and use cases the model will be utilized for. It may entail supervised learning, but can also involve reinforcement learning, self-supervised learning or semi-supervised learning. Fine-tuning techniques used in the various embodiments may include but are not limited to full fine-tuning where a configuration parameter such as model attributes that influence the learning process, might be modified relative to their specifications during pre-training; and parameter efficient fine-tuning (PEFT). PEFT further comprises partial fine-tuning to reduce computational demands by updating only the select subset of pre-trained parameters to update only the outer layers of the neural network; additive fine-tuning by adding extra parameters or layers to the model, freeze the existing pre-trained weights, and train only those new components; and reparameterization-based methods like Low Rank Adaptation (LoRA) leverage low-rank transformation of high-dimensional matrices (like the massive matrix of pre-trained model weights in a transformer model). These low-rank representations omit inconsequential higher-dimensional information in order to capture the underlying low-dimensional structure of model weights, greatly reducing the number of trainable parameters. This dramatically speeds up fine-tuning and reduces memory needed to store model updates.

In some embodiments, the fine-tuned model is benchmarked on a benchmark dataset to determine a second benchmark metric. A checkpoint of the model may in embodiments be established. A checkpoint is a snapshot of a model's state. For example, a checkpoint allows training to resume from the last saved state if the training process is interrupted. Checkpoints are saved in non-volatile memory. They include weights, biases, and other parameters. They can be saved manually or automatically. They can be used to monitor model development and identify potential issues. They are a fault tolerance technique that allows the training process to resume from a known state.

At step 550, a decision is made whether distill an update of the classification model. For example, a comparison instruction is executed to output a result of a determination whether to distill an update of the classification model based on a comparison between the first benchmark metric and the second benchmark metric. In another example, the comparison is based on whether the second benchmark metric is below a threshold compared to the first benchmark metric. If the threshold is below a specified level for instance to indicate YES that the performance of the classification model has degraded with statistical significance (e.g. 95%/99% confidence), then continue to step 560. Otherwise, the decision is NO, the process ends.

At step 560, the random sample current production data and random sample previous production data is performed. For example, during this step, randomly sample k data points from a previous iteration production data i.e. production data from a previously checkpointed classification model, where k is determined as 1/2 the size of this iteration's production data. Use the previous iteration's model to generate soft-labels for these k samples. Use the current iteration's model, i.e. currently checkpointed model, to generate soft-labels for k samples randomly chosen from this iteration's production data. At step 570, distill updated model is performed based on these 2k samples (which all contain soft-labels). Use this distilled model to overwrite this current iteration's checkpoint. The process then ends.

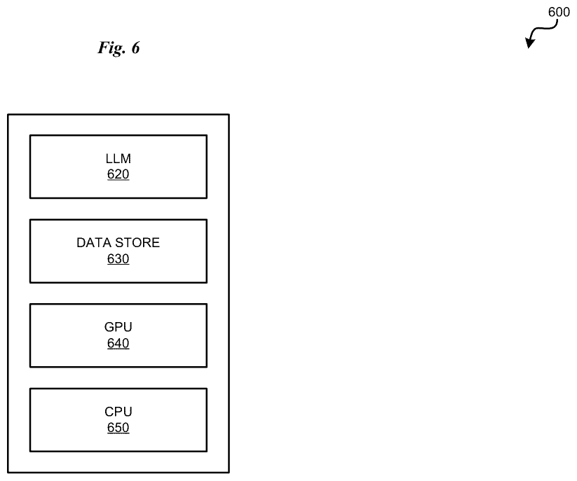

FIG. 6 depicts a system diagram that illustrates an example system for guard railing of a large language model using production data augmentation in an environment in accordance with an illustrative embodiment. In a particular embodiment, the components of the diagram 600 show aspects of the components of FIGS. 1-6.

In the illustrated embodiment, the system may comprise a Large Language Model (LLM) 620, a data store 630, a general processing unit (GPU) 640, and a central processing unit (CPU) 650. The LLM 620 may comprise a neural network with an encoder-decoder architecture accepting input feature vectors to the machine learning model to perform predictions. The LLM 620 may further comprise a model training interface, an output interface, and a fine-tuning interface. GPU 640 due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models.

A physical data storage device is the underlying technology behind a data store 630. The data store may comprise formats such as files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

In some embodiments, the data store stores a persistent attribute of a credential. Database persistence is the process of storing data in a way that allows it to be retrieved later, even after the application that created it has closed. This ensures that data remains accessible, reliable, and intact. Data is written to non-volatile storage, which can retain information long-term. Non-volatile storage can include hard disk drives (HDDs), cloud storage, or other storage devices. Persistent data can be accessed and updated across multiple transactions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
training a classification model by sending data from a seed dataset to a model training interface of the classification model wherein the seed dataset comprises a classification, and determining a first benchmark metric;
iteratively executing the classification model on a production dataset wherein for each iteration of the production dataset, the classification model executes to determine a set of samples wherein each sample from the set of samples is predicted to comprise the classification;
generating an annotation of the set of samples based on clustering of the set of samples;
issuing an instruction via a fine-tuning interface of the classification model, the instruction executing to modify a configuration parameter of the classification model based on the annotation to cause the classification model to determine a second benchmark metric and establishing a checkpoint wherein the checkpoint is incremented for each iteration of the production dataset; and
executing a comparison instruction to output a result of a determination whether to distill an update of the classification model based on a comparison between the first benchmark metric and the second benchmark metric.

2. The computer-implemented method of claim 1, wherein the update of the classification model comprises distilling a model based on randomly sampled first k data points from a current production dataset and randomly sampled second k data points from a production dataset associated with the classification model with a previous checkpoint.

3. The computer-implemented method of claim 2, further comprising generating a first soft label using the classification model with a current checkpoint on the first k data points and a second soft label using the classification model with a previous checkpoint on the second k data points.

4. The computer-implemented method of claim 1, wherein the clustering comprises generating an embedding for each sample of the set of samples and applying a clustering algorithm on the embedding.

5. The computer-implemented method of claim 1, wherein generating the annotation comprises generating an annotation for a centroid of each cluster generated by the clustering and applying the annotation to all points in the cluster.

6. The computer-implemented method of claim 1, wherein determining the first benchmark metric and the second benchmark metric uses a benchmark comprising of academic and conversational data.

7. The computer-implemented method of claim 1, wherein the comparison is based on whether the second benchmark metric is below a threshold compared to the first benchmark metric.

8. A computer program product comprising one or more computer readable storage media, and program instructions collectively stored on the one or more computer readable storage media, the program instructions executable by a processor to cause the processor to perform operations comprising:
training a classification model by sending data from a seed dataset to a model training interface of the classification model wherein the seed dataset comprises a classification, and determining a first benchmark metric;
iteratively executing the classification model on a production dataset wherein for each iteration of the production dataset, the classification model executes to determine a set of samples wherein each sample from the set of samples is predicted to comprise the classification;
generating an annotation of the set of samples based on clustering of the set of samples;
issuing an instruction via a fine-tuning interface of the classification model, the instruction executing to modify a configuration parameter of the classification model based on the annotation to cause the classification model to determine a second benchmark metric and establishing a checkpoint wherein the checkpoint is incremented for each iteration of the production dataset; and
executing a comparison instruction to output a result of a determination whether to distill an update of the classification model based on a comparison between the first benchmark metric and the second benchmark metric.

9. The computer program product of claim 8, wherein the update of the classification model comprises distilling a model based on randomly sampled first k data points from a current production dataset and randomly sampled second k data points from a production dataset associated with the classification model with a previous checkpoint.

10. The computer program product of claim 9, further comprising generating a first soft label using the classification model with a current checkpoint on the first k data points and a second soft label using the classification model with a previous checkpoint on the second k data points.

11. The computer program product of claim 8, wherein generating the annotation comprises generating an annotation for a centroid of each cluster generated by the clustering and applying the annotation to all points in the cluster.

12. The computer program product of claim 8, wherein the clustering comprises generating an embedding for each sample of the set of samples and applying a clustering algorithm on the embedding.

13. The computer program product of claim 8, wherein determining the first benchmark metric and the second benchmark metric uses a benchmark comprising of academic and conversational data.

14. The computer program product of claim 8, wherein the comparison is based on whether the second benchmark metric is below a threshold compared to the first benchmark metric.

15. A computer system comprising a processor and one or more computer readable storage media, and program instructions collectively stored on the one or more computer readable storage media, the program instructions executable by the processor to cause the processor to perform operations comprising:
training a classification model by sending data from a seed dataset to a model training interface of the classification model wherein the seed dataset comprises a classification, and determining a first benchmark metric;
iteratively executing the classification model on a production dataset wherein for each iteration of the production dataset, the classification model executes to determine a set of samples wherein each sample from the set of samples is predicted to comprise the classification;
generating an annotation of the set of samples based on clustering of the set of samples;
issuing an instruction via a fine-tuning interface of the classification model, the instruction executing to modify a configuration parameter of the classification model based on the annotation to cause the classification model to determine a second benchmark metric and establishing a checkpoint wherein the checkpoint is incremented for each iteration of the production dataset; and
executing a comparison instruction to output a result of a determination whether to distill an update of the classification model based on a comparison between the first benchmark metric and the second benchmark metric.

16. The computer system of claim 15, wherein the update of the classification model comprises distilling a model based on randomly sampled first k data points from a current production dataset and randomly sampled second k data points from a production dataset associated with the classification model with a previous checkpoint.

17. The computer system of claim 16, further comprising generating a first soft label using the classification model with a current checkpoint on the first k data points and a second soft label using the classification model with a previous checkpoint on the second k data points.

18. The computer system of claim 15, wherein generating the annotation comprises generating an annotation for a centroid of each cluster generated by the clustering and applying the annotation to all points in the cluster.

19. The computer system of claim 15, wherein the clustering comprises generating an embedding for each sample of the set of samples and applying a clustering algorithm on the embedding.

20. The computer system of claim 15, wherein the comparison is based on whether the second benchmark metric is below a threshold compared to the first benchmark metric.
